(19) United States
(12) Patent Application Publication
(10) Pub. No.: US 2024/0119392 A1
(43) Pub. Date: Apr. 11, 2024

(54) INFORMATION PROCESSING APPARATUS, INFORMATION PROCESSING METHOD, AND PROGRAM

(71) Applicant: Sony Group Corporation, Tokyo (JP)

(72) Inventors: Takao TAJIRI, Tokyo (JP); Takahiro ISHIKAWA, Tokyo (JP)

(73) Assignee: Sony Group Corporation, Tokyo (JP)

(21) Appl. No.: 18/546,100

(22) PCT Filed: Jan. 13, 2022
(86) PCT No.: PCT/JP2022/000892

§ 371 Date: Aug. 11, 2023

(30) Foreign Application Priority Data
Mar. 16, 2021 (JP) 2021-042030

(51) Int. Cl. G06Q 10/0637; G06F 40/40

(52) U.S. Cl. CPC G06Q 10/0637; G06F 40/40

(57) ABSTRACT

An information processing apparatus includes an evaluation section that inputs to a first classifier generated by supervised learning that uses a feature amount extracted from text in which a characteristic of a comparison target evaluated to satisfy a predetermined evaluation criteria defined by a combination of multiple sub goals of the predetermined goal is described, a feature amount extracted from the text in which the characteristic of the evaluation target is described, to acquire a similarity between the evaluation target and the comparison target for each of the sub goals. Further, the evaluation section evaluates, in reference to the similarity between the evaluation target and the comparison target for each of the sub goals and an ideal pattern for each of the predetermined evaluation criteria defined by a combination of the multiple sub goals, the similarity between the ideal pattern for each of the predetermined evaluation criteria and evaluation target.

### TECHNICAL FIELD

The present disclosure relates to an information processing apparatus, an information processing method, and a program.

### BACKGROUND ART

In recent years, a technology for performing evaluation of an evaluation target for some kind of goal has been developed. For example, PTL 1 discloses a technology for performing evaluation of a service in relation to SDGs (Sustainable Development Goals).

### CITATION LIST

### Patent Literature

### [PTL 1]

Japanese Patent Laid-Open No. 2020-135726

### SUMMARY

### Technical Problem

However, the evaluation method disclosed in PTL 1 remains in relative evaluation based on an existing service that has been made clear to contribute to a goal.

### Solution to Problem

According to a certain aspect of the present disclosure, there is provided an information processing apparatus including an evaluation section that performs, in reference to a text in which a characteristic of an evaluation target is described, evaluation of the evaluation target for a predetermined goal including multiple sub goals, in which the evaluation section inputs, to a first classifier generated by supervised learning that uses a feature amount extracted from a text in which a characteristic of a comparison target evaluated to satisfy any one of predetermined evaluation criteria defined by a combination of respective ones of the multiple sub goals of the predetermined goal is described, a feature amount extracted from the text in which the characteristic of the evaluation target is described, to acquire a similarity between the evaluation target and the comparison target for each of the sub goals, and evaluates, in reference to the similarity between the evaluation target and the comparison target for each of the sub goals and an ideal pattern for each of the predetermined evaluation criteria defined by a combination of respective ones of the multiple sub goals, a similarity between the ideal pattern for each of the predetermined evaluation criteria and the evaluation target.

Further, according to another aspect of the present disclosure, there is provided an information processing method performed by a processor, including performing, in reference to a text in which a characteristic of an evaluation target is described, evaluation of the evaluation target for a predetermined goal including multiple sub goals, in which the performing evaluation further includes inputting, to a first classifier generated by supervised learning that uses a feature amount extracted from a text in which a characteristic of a comparison target evaluated to satisfy any one of predetermined evaluation criteria defined by a combination of respective ones of the multiple sub goals of the predetermined goal is described, a feature amount extracted from the text in which the characteristic of the evaluation target is described, to acquire a similarity between the evaluation target and the comparison target for each of the sub goals, and evaluating, in reference to the similarity between the evaluation target and the comparison target for each of the sub goals and an ideal pattern for each of the predetermined evaluation criteria defined by a combination of respective ones of the multiple sub goals, a similarity between the ideal pattern for each of the predetermined evaluation criteria and the evaluation target.

Further, according to a further aspect of the present disclosure, there is provided a program for causing a computer to function as an information processing apparatus that includes an evaluation section that performs, in reference to a text in which a characteristic of an evaluation target is described, evaluation of the evaluation target for a predetermined goal including multiple sub goals, in which the evaluation section inputs, to a first classifier generated by supervised learning that uses a feature amount extracted from a text in which a characteristic of a comparison target evaluated to satisfy any one of predetermined evaluation criteria defined by a combination of respective ones of the multiple sub goals of the predetermined goal is described, a feature amount extracted from the text in which the characteristic of the evaluation target is described, to acquire a similarity between the evaluation target and the comparison target for each of the sub goals, and evaluates, in reference to the similarity between the evaluation target and the comparison target for each of the sub goals and an ideal pattern for each of the predetermined evaluation criteria defined by a combination of respective ones of the multiple sub goals, a similarity between the ideal pattern for each of the predetermined evaluation criteria and the evaluation target.

### BRIEF DESCRIPTION OF DRAWINGS

FIG. 1 is a flow chart depicting an example of a flow of an evaluation method according to an embodiment of the present disclosure.

FIG. 2 is a block diagram depicting an example of a functional configuration of an evaluation apparatus 10 according to the embodiment.

FIG. 3 is a view illustrating screening according to the embodiment.

FIG. 4 is a view depicting an example of a target score TS according to the embodiment.

FIG. 5 is a view depicting an example of a two-dimensional map TM according to the embodiment.

FIG. 6 is a view illustrating in detail rating of an evaluation target according to the embodiment.

FIG. 7 is a view depicting an example of a by-sub goal score SS according to the embodiment.

FIG. 8 is a view depicting an example of evaluation criterion definition information SI according to the embodiment.

FIG. 9 is a view illustrating calculation of a similarity between the evaluation criterion definition information SI and the by-goal score SS according to the embodiment.

FIG. 10 is a view illustrating an example of rating according to the embodiment.

FIG. 11 is a view depicting an example of an output of a rating result and so forth according to the embodiment.

FIG. 12 is a view illustrating emphatic displaying of a sentence that has contributed to improvement of the similarity between an evaluation target and a comparison target for each sub goal according to the embodiment.

FIG. 13 is a view illustrating emphatic displaying of a sentence that has contributed to improvement of the similarity between an evaluation target and a comparison target for each sub goal according to the embodiment.

FIG. 14 is a view illustrating anomaly detection based on time-sequence evaluation according to the embodiment.

FIG. 15 is a view depicting an example of an estimation result ER of the time sequence evaluation according to the embodiment.

FIG. 16 is a block diagram depicting an example of a hardware configuration of an information processing apparatus 90 according to the embodiment.

### DESCRIPTION OF EMBODIMENT

In the following, a preferred embodiment of the present disclosure is described in detail with reference to the accompanying drawings. It is to be noted that, in the present specification and the drawings, components having substantially the same functional configurations are denoted by identical reference signs and overlapping description of them is omitted.

It is to be noted that the description is given in the following order.
1. Embodiment
   1.1. Overview
   1.2. Example of functional configuration of evaluation apparatus 10
   1.3. Details of screening
   1.4. Details of rating
   1.5. Details of anomaly detection
   1.6. Advantageous effects
2. Example of hardware configuration
3. Summary

### 1. Embodiment

<<1.1. Overview>>

As described hereinabove, in recent years, a technology for performing evaluation of an evaluation target for a certain goal has been developed.

One example of the goal mentioned above is SDGs. SDGs are international goals established by the United Nations for sustainable development.

In recent years, enterprises that strive to improve their impression by appealing their own efforts related to the SDGs to stake holders are also increasing.

Further, SDGs bonds that are bonds to be allocated to businesses whose raised funds contribute to the SDGs are also attracting attention.

The SDGs bonds include a green bond, a social bond, and a sustainability bond.

A green bond refers to receivables whose fund is allocated to fundraising of a project (green project) having clear environmental benefits.

A social bond refers to receivables whose fund is allocated to fundraising of social projects including a project directly aimed at responding to or mitigating a predetermined social issue, a project that aims to achieve a positive social achievement, and so forth.

Meanwhile, a sustainability bond refers to receivables whose fund is allocated to fundraising of a combination of a green project and a social project.

However, in the current situations, certification (rating) of such SDGs bonds as described above is performed manually by an evaluation agency, requiring a lot of costs. Thus, the number of receivables accepted as SDGs bonds is still small, and many receivables that should originally be accepted as SDGs bonds are considered to be buried among non-SDGs bonds.

In order to expand the market of SDGs bonds, it is significant to reduce the cost required for evaluation of SDGs bonds and also ensure the quality of evaluation.

The technical idea in the present disclosure has been conceived of focusing on such points as described above and effectively reduces the cost for evaluation for a predetermined goal while ensuring the quality of the evaluation.

In order to implement the foregoing, an evaluation apparatus 10 according to an embodiment of the present disclosure has one of the characteristics in that it performs evaluation of an evaluation target in reference to a similarity between a text in which a characteristic of a comparison target determined to satisfy a certain criterion for a predetermined goal is described and a text in which a characteristic of the evaluation target is described.

According to the characteristic described above, it is possible to eliminate, in evaluation of an evaluation target for a predetermined goal, much manual work and significantly reduce the cost required for evaluation.

Further, the evaluation apparatus 10 according to the embodiment of the present disclosure has one of the characteristics in that it performs, in addition to relative evaluation by comparison with the comparison target, absolute evaluation based on a criterion set for the predetermined goal, to thereby comprehensively perform evaluation of the comparison target.

According to the characteristic described above, it is possible to implement more detailed evaluation of higher quality in comparison with that in an alternative case in which only relative evaluation is performed. Further, according to the characteristic described above, by changing the criterion for the predetermined goal according to a situation or the like, it is possible to implement more flexible evaluation.

Here, an overview of an evaluation method according to the embodiment of the present disclosure is described.

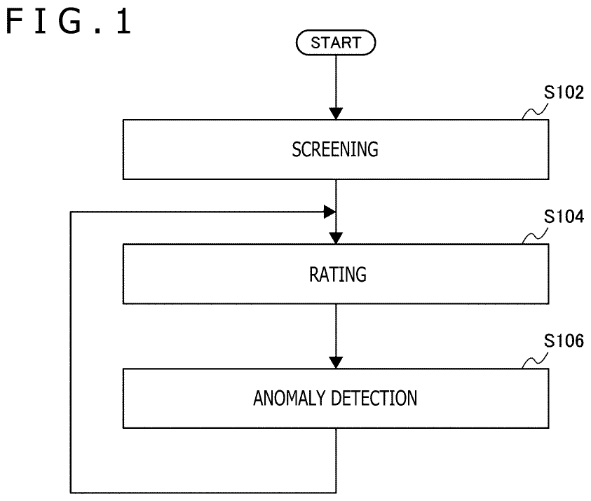

FIG. 1 is a flow chart depicting an example of a flow of the evaluation method according to the present embodiment.

As depicted in FIG. 1, the evaluation method according to the present embodiment may include three steps of screening (S102), rating (S104), and anomaly detection (S106).

In the screening in step S102, a process for screening appropriate evaluation targets as a target of rating from among screening targets is performed.

By this process, narrowing down evaluation targets from a great number of candidates makes it possible to effectively reduce the cost required for rating.

Further, in the rating in step S104, for the evaluation targets screened in step S102, there is performed rating which is based on comprehensive evaluation including relative evaluation with respect to a comparison target and absolute evaluation based on a criterion set for a predetermined goal.

By the rating, more detailed and higher-quality evaluation and more flexible evaluation can be implemented in comparison with those in such an alternative case in which only relative evaluation is performed as described above.

Further, in the anomaly detection in step S106, detection of a predetermined anomalous pattern is performed in reference to time series evaluation of the evaluation target.

As the predetermined anomalous pattern just described, for example, significant fluctuation of evaluation and so forth are available.

By the detection, it is possible to successively evaluate the evaluation target and detect, in a case where fluctuation occurs with the evaluation or in a like case, the fluctuation and then notify the user of this.

An overview of the evaluation method according to the present embodiment has been described above. In the following, an example of a configuration of the evaluation apparatus 10 that implements the evaluation method is described.

It is to be noted that, in the following description, a case in which the predetermined goal according to the present embodiment is SDGs and the evaluation target is SDGs bonds is described as a main example.

<<1.2. Example of Functional Configuration of Evaluation Apparatus 10>>

The evaluation apparatus 10 according to the present embodiment is an example of an information processing apparatus that performs evaluation of an evaluation target for a predetermined goal including multiple sub goals, in reference to a text in which a characteristic of the evaluation target is described.

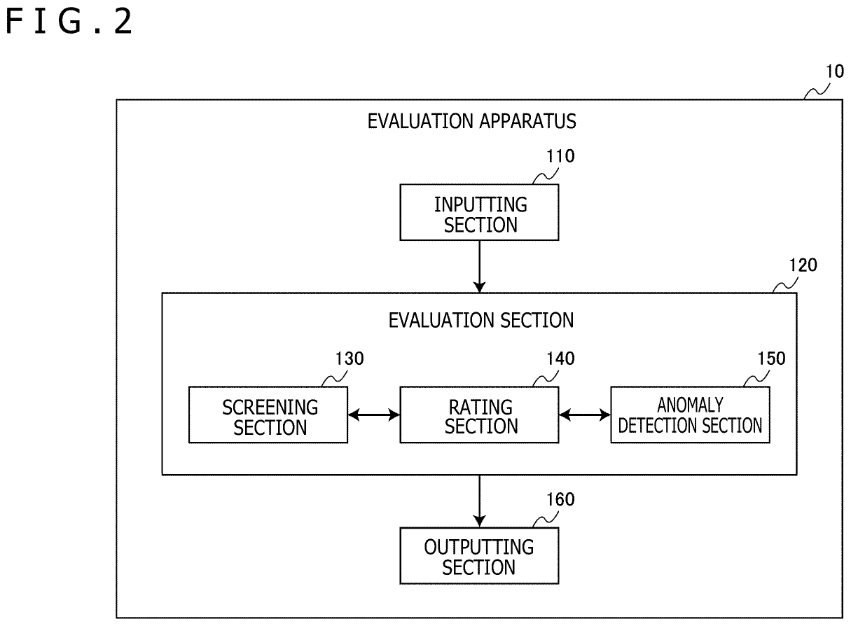

FIG. 2 is a block diagram depicting an example of a functional configuration of the evaluation apparatus 10 according to the present embodiment.

As depicted in FIG. 2, the evaluation apparatus 10 according to the present embodiment may include an inputting section 110, an evaluation section 120, and an outputting section 160.

Further, the evaluation section 120 may include a screening section 130 that executes the screening in step S102 described above, a rating section 140 that performs the rating in step S104, and an anomaly detection section 150 in step S106.

(Inputting Section 110)

The inputting section 110 according to the present embodiment inputs information to the evaluation section 120 according to an operation performed by the user.

Hence, the inputting section 110 according to the present embodiment includes an inputting device such as a mouse or a keyboard.

The information described above includes, for example, a text in which a characteristic of a screening target is described, a text in which a characteristic of an evaluation target is described, a comment of a third person on an evaluation target, a text on which a characteristic of a comparison target is described, and so forth.

(Evaluation Section 120)

The evaluation section 120 according to the present embodiment performs evaluation of an evaluation target for a predetermined goal including multiple sub goals, in reference to a text in which a characteristic of the evaluation target is described.

The predetermined goal described above may be, for example, SDGs. In this case, the multiple sub goals may be 17 by-field goals defined in the SDGs.

Further, the evaluation section 120 according to the present embodiment may acquire a similarity between an evaluation target and a comparison target for each sub goal by inputting, to a first classifier, a feature amount extracted from a text in which a characteristic of the evaluation target is described.

The comparison target according to the present embodiment may be, for example, a financial instrument.

As an example, in a case where the predetermined goal is SDGs, the evaluation target according to the present embodiment may be receivables having the possibility of being an SDGs bond.

In this case, the comparative target may be an SDGs bond evaluated by an evaluation agency as satisfying any one of predetermined evaluation criteria each defined by a combination of multiple sub goals.

Further, the first classifier described above may be a classification model generated by supervised learning that uses a feature amount extracted from a text in which a characteristic of a comparison target is described.

Further, it is one of the characteristics that the evaluation section 120 according to the present embodiment evaluates a similarity between an ideal pattern for each of the predetermined evaluation criteria and an evaluation target in reference to a similarity between an evaluation target and a comparison target for each of sub goals acquired using the first classifier and an ideal pattern for each of the predetermined evaluation criteria defined by a combination of multiple sub goals.

For example, in a case where the predetermined goal is SDGs, the predetermined evaluation criteria may include a green criterion, a social criterion, and a sustainability criterion.

For example, the green criterion is defined by a combination of multiple sub goals relating to a green project from among the 17 sub goals.

Meanwhile, for example, the social criterion is defined by a combination of multiple sub goals relating to a social project from among the 17 sub goals.

Further, for example, the sustainability criterion is defined by a combination of multiple sub goals relating in common to a green project and a social project from among the 17 sub goals.

The evaluation section 120 according to the present embodiment may perform rating of an evaluation target for a predetermined goal in reference to such a similarity between an ideal pattern for each of the predetermined evaluation criteria and an evaluation target as described above.

With the evaluation section 120 according to the present embodiment, since both relative evaluation by comparison with a comparison target and absolute evaluation based on a predetermined evaluation criterion are applied, it is possible to implement more detailed and higher-quality evaluation.

Further, with the evaluation section 120 according to the present embodiment, by the ideal pattern of the predetermined evaluation criterion being changed according to a situation or the like, more flexible evaluation can be implemented.

The functions of the evaluation section 120 according to the present embodiment are implemented by various processors. Details of the functions of the evaluation section 120 according to the present embodiment are described separately.

(Outputting Section 160)

The outputting section 160 according to the present embodiment outputs a result of evaluation by the evaluation section 120.

To this end, the outputting section 160 according to the present embodiment includes various displays, printers, and so forth.

An example of an output by the outputting section 160 according to the present embodiment is described separately.

The example of the functional configuration of the evaluation apparatus 10 according to the present embodiment has been described. It is to be noted that the functional configuration described above with reference to FIG. 2 is an example to the end and the functional configuration of the evaluation apparatus 10 according to the present embodiment is not restricted to such an example as described above.

The functional configuration of the evaluation apparatus 10 according to the present embodiment can be modified flexibly according to specifications, operation, or the like.

<<1.3. Details of Screening>>

Now, screening of an evaluation target by the screening section 130 according to the present embodiment is described in detail.

The screening section 130 according to the present embodiment screens evaluation targets from among screening targets. Since the screening section 130 narrows down evaluation targets from among a great number of candidates, the cost required for rating can be reduced effectively.

At this time, the screening section 130 according to the present embodiment may determine whether or not a screening target is suitable as an evaluation target, in reference to a text in which a characteristic of the screening target is described.

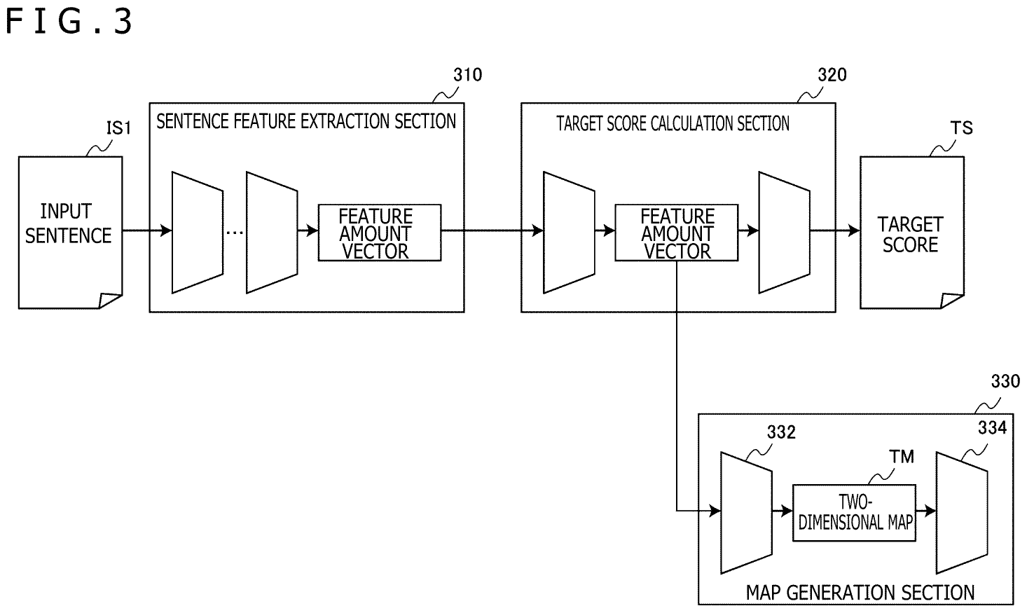

FIG. 3 is a view illustrating screening according to the present embodiment.

As depicted in FIG. 3, the screening section 130 according to the present embodiment may include a sentence feature extraction section 310, a target score calculation section 320, and a map generation section 330.

In the screening according to the present embodiment, first, an input sentence IS1 is inputted first to the sentence feature extraction section 310.

Here, the input sentence IS1 is a free description sentence including non-financial information in which a characteristic of a screening target is described, and the data format and the description language are not restricted.

In a case where the screening target is a financial instrument such as receivables, the input sentence IS1 may be various texts including information concerning the financial instrument or an issuer of the financial instrument.

The input sentence IS1 may be, for example, a shelf registration supplement, a securities report, an integrated report, a sustainability report, or the like.

The sentence feature extraction section 310 according to the present embodiment extracts a feature amount vector from the input sentence IS1 by a natural language process using a neural network. It is to be noted that a rhombus in FIG. 3 indicates a neural network.

The sentence feature extraction section 310 according to the present embodiment may extract a feature amount vector from the input sentence IS1, for example, by BERT (Bidirectional Encoder Representations from Transformers).

The feature amount vector extracted from the input sentence IS1 is inputted to the target score calculation section 320.

The target score calculation section 320 according to the present embodiment acquires a target score TS indicative of a similarity between a comparison target and a screening target for each of the predetermined evaluation criteria, by inputting the feature amount vector extracted from the input sentence IS1 to a second classifier.

The second classifier is generated by supervised learning that uses a feature amount extracted from a text in which a characteristic of a comparison target evaluated by an evaluation agency as satisfying any one of the predetermined evaluation criteria is described.

The second classifier may be generated using a model of, for example, BiLSTM (Bidirectional Long Short Term Memory) or the like.

It is to be noted that, in a case where the predetermined goal is SDGs, the comparison target may be a green bond, a social bond, or a sustainability bond certified by an evaluation agency.

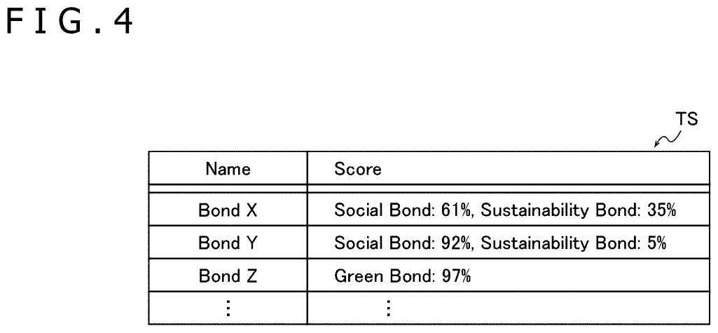

In this case, as depicted in FIG. 4, the target score TS may include a probability of being a green bond, a probability of being a social bond, or a probability of being sustainability bond for each screening target.

FIG. 4 is a view depicting an example of the target score TS according to the present embodiment. In the case of the example depicted in FIG. 4, the probability of being a social bond and the probability of being a sustainability bond of the screening target “Bond X” are 61% and 35%, respectively.

Further, the probability of being a social bond and the probability of being a sustainability bond of the screening target “Bond Y” are 92% and 5%, respectively.

Further, the probability of being a green bond of the screening target “Bond Z” is 97%.

The screening section 130 according to the present embodiment may determine whether or not the screening target is appropriate as an evaluation target, in reference to such a target score TS as described above, and perform screening in reference to a result of the determination.

As an example, the screening section 130 may screen, as an evaluation target, a screening target in regard to which one of the probability of being a green bond, the probability of being a social bond, and the probability of being a sustainability bond exceeds a predetermined criterion.

Further, the map generation section 330 according to the present embodiment may generate a two-dimensional map in which the similarity between a comparison target and a screening target for each of the predetermined evaluation criterion is represented by a distance in a two-dimensional space.

The map generation section 330 according to the present embodiment may generate a two-dimensional map TM by inputting a feature amount vector obtained in an intermediate layer of the classifier described above to the encoder 332 generated by learning, for example, relating to a variational auto-encoder (VAE: Variational Auto-Encoder).

It is to be noted that, in generation of the two-dimensional map TM, the output of the decoder 334 may be discarded.

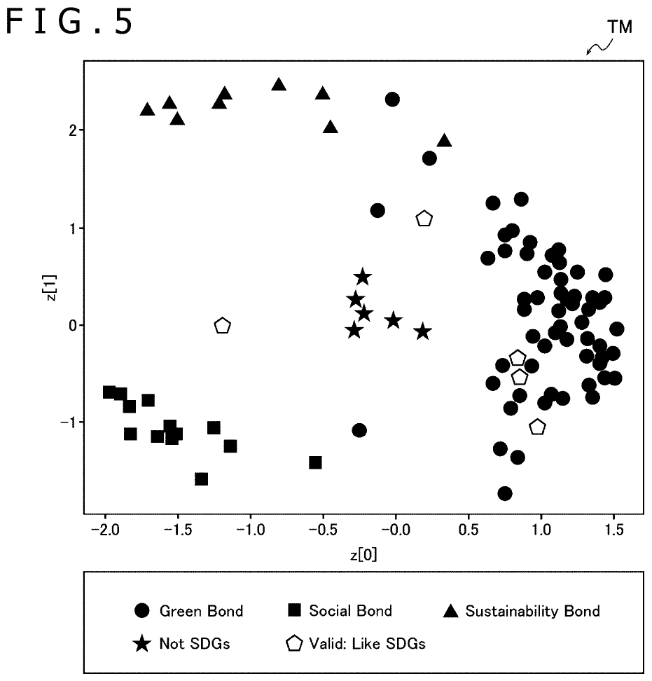

FIG. 5 is a view depicting an example of the two-dimensional map TM according to the present embodiment. In the case of the example depicted in FIG. 5, a green bond, a social bond, a sustainability bond, and a non-SDGs bond that are comparison targets are represented by a circle, a square, a triangle and a star-shaped marker all indicated in black, respectively.

Further, in the case of the example depicted in FIG. 5, receivables that are a screening target are represented by a marker of a white pentagon.

The outputting section 160 according to the present embodiment may output not only such a target score TS as depicted in FIG. 4 but also such a two-dimensional map TM as depicted in FIG. 5 to a display.

This makes it possible to recognize a detailed value relating to a similarity between a comparison target and a screening target and visually recognize the similarity in an intuitive manner.

<<1.4. Details of Rating>>

Now, details of rating of an evaluation target by the rating section 140 according to the present embodiment are described.

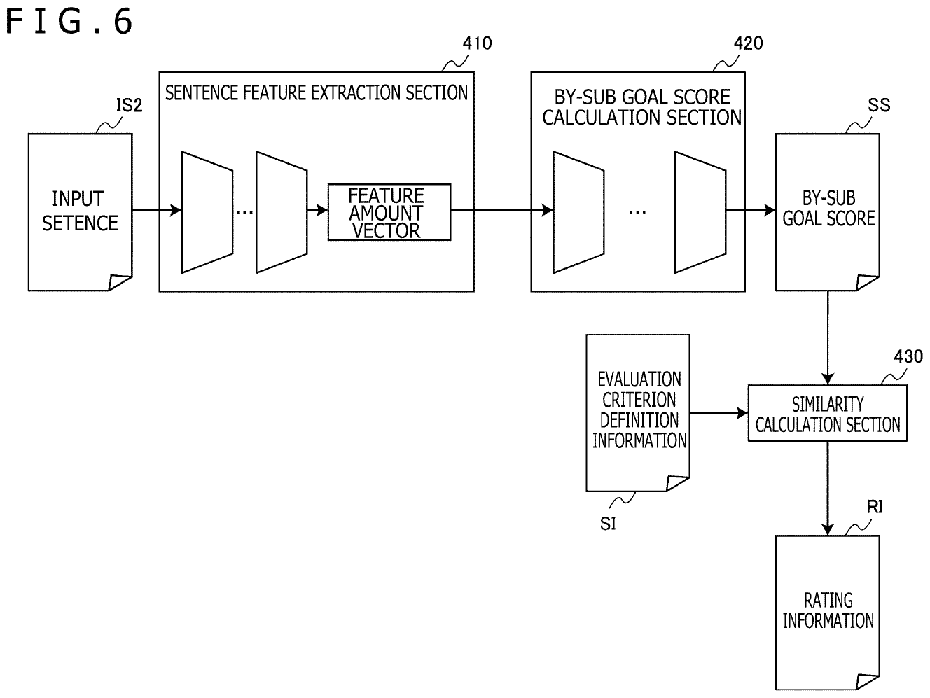

FIG. 6 is a view illustrating details of rating of an evaluation target according to the present embodiment.

As depicted in FIG. 6, the rating section 140 according to the present embodiment may include a sentence feature extraction section 410, a by-sub goal score calculation section 420, and a similarity calculation section 430.

In the screening according to the present embodiment, first, an input sentence IS2 is inputted to the sentence feature extraction section 410.

Here, the input sentence IS2 is a free description sentence including non-financial information in which a characteristic of an evaluation target is described, and the data format and the description language are not restricted.

In a case where the evaluation target is a financial instrument such as receivables, the input sentence IS2 may be various texts including information concerning the financial instrument or an issuer of the financial instrument.

The input sentence IS2 may be, for example, a shelf registration supplement, a securities report, an integrated report, a sustainability report, or the like.

The sentence feature extraction section 310 according to the present embodiment extracts a feature amount vector from the input sentence IS2 by a natural language process using a neural network. It is to be noted that a rhombus in FIG. 6 indicates a neural network.

The sentence feature extraction section 410 according to the present embodiment may extract a feature amount vector from the input sentence IS2 by, for example, BERT.

The feature amount vector extracted from the input sentence IS2 is inputted to the by-sub goal score calculation section 420.

The by-sub goal score calculation section 420 according to the present embodiment acquires a by-sub goal score SS indicative of a similarity between an evaluation target and a comparison target for each sub goal, by inputting the feature amount vector extracted from the input sentence IS2 to the first classifier.

Similarly to the second classifier, the first classifier described above may be a classification model generated by supervised learning that uses a feature amount extracted from a text in which a characteristic of a comparison target evaluated by an evaluation agency as satisfying any one of the predetermined evaluation criteria is described.

However, different from the second classifier, the first classifier outputs a value relating to a similarity between an evaluation target and a comparison target for each sub goal.

The first classifier may be generated, for example, using a model of BiLSTM or the like.

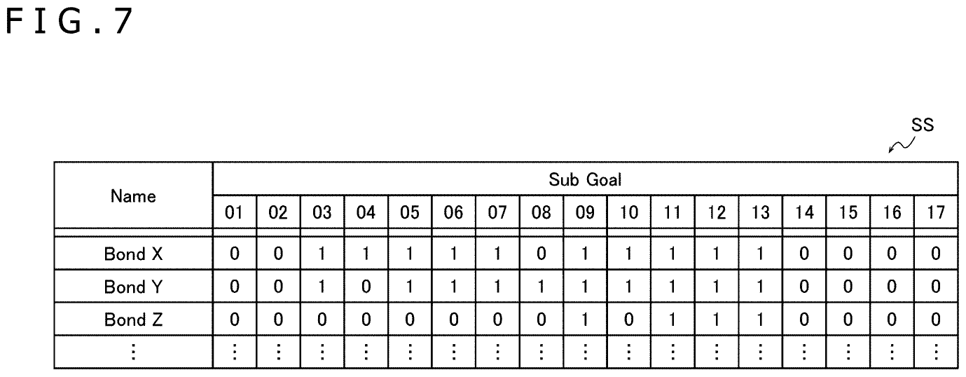

FIG. 7 is a view depicting an example of the by-sub goal score SS according to the present embodiment. It is to be noted that FIG. 7 exemplifies a by-sub goal score SS in a case where the predetermined goal is SDGs and the sub goal is a goal for each of the 17 fields defined by the SDGs.

Further, in the example depicted in FIG. 7, a value obtained by rounding the similarity to a comparison target for each sub goal to any one of “0” or “1” is indicated.

For example, the evaluation target “Bond X” is similar in the sub goals “03” to “07” and “09” to “13” to the SDGs bond that is the comparison target.

Meanwhile, the evaluation target “Bond Y” is similar in the sub goals “03” and “05” to “13” to the SDGs bond that is the comparison target.

Further, the evaluation target “Bond Z” is similar in the sub goals “09” and “11” to “13” to the SDGs bond that is the comparison target.

With such a by-sub goal score SS as described above, it is possible to perform evaluation of an evaluation target for a predetermined goal in reference to relative comparison with a comparison target.

Moreover, the similarity calculation section 430 according to the present embodiment may further perform absolute evaluation based on evaluation criterion definition information SI that defines an ideal pattern for each of the predetermined evaluation criteria.

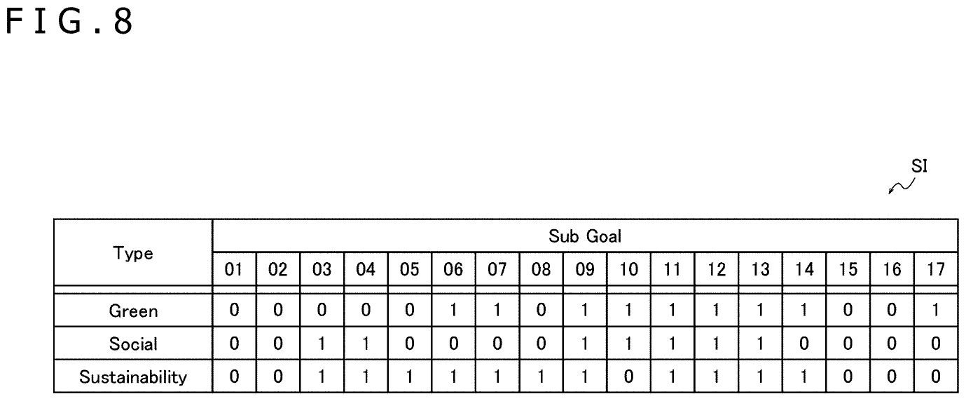

FIG. 8 is a view depicting an example of the evaluation criterion definition information SI according to the present embodiment. It is to be noted that FIG. 8 exemplifies the evaluation criterion definition information SI in a case where the predetermined goal is SDGs and the sub goal is a goal for each of the 17 fields defined by the SDGs.

For example, the evaluation criterion “green” is defined by the combination of the sub goals “06,” “07,” “09” to “14,” and “17.”

Meanwhile, the evaluation criterion “social” is defined by the combination of the sub goals “03,” “04,” and “09” to “13.”

Further, the evaluation criterion “sustainability” is defined by the combination of the sub goals “03” to “09” and “11” to “14.”

The similarity calculation section 430 according to the present embodiment may calculate a similarity between such evaluation criterion definition information SI as described above and the by-sub goal score SS.

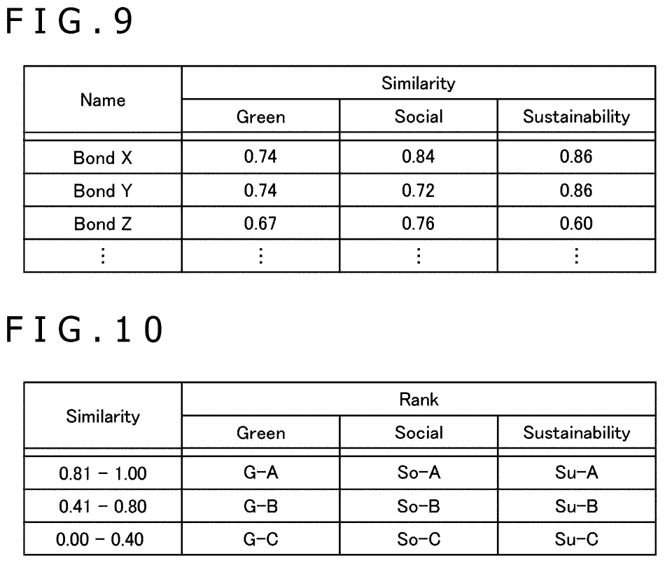

FIG. 9 is a view illustrating calculation of a similarity between the evaluation criterion definition information SI and the by-sub goal score SS according to the present embodiment.

The similarity calculation section 430 according to the present embodiment may, for example, compare the values (“0” or “1”) of the evaluation criterion definition information SI and the by-sub goal score SS for each sub goal and calculate a similarity by summarizing results of the comparison for each evaluation criterion.

In the case of the example depicted in FIG. 9, the evaluation target “Bond X” has a similarity of 74% with the evaluation criterion “green,” a similarity of 84% with the evaluation criterion “social,” and a similarity of 86% with the evaluation criterion “sustainability.”

Meanwhile, the evaluation target “Bond Y” has a similarity of 74% with the evaluation criterion “green,” a similarity of 72% with the evaluation criterion “social,” and a similarity of 86% with the evaluation criterion “sustainability.”

Further, the evaluation target “Bond Z” has a similarity of 67% with the evaluation criterion “green,” a similarity of 76% with the evaluation criterion “social,” and a similarity of 60% with the evaluation criterion “sustainability.”

Meanwhile, the similarity calculation section 430 according to the present embodiment may output rating information RI in reference to such a similarity as described above.

FIG. 10 is a view illustrating an example of rating of an evaluation target according to the present embodiment.

The rating of an evaluation target according to the present embodiment may be determined, for example, in reference to an evaluation criterion of the highest similarity among the similarities between the evaluation criterion definition information SI and the by-sub goal score SS described hereinabove.

For example, in a case where the similarity regarding the evaluation criterion “green” is highest, the rating of the applicable evaluation target may be decided to be any one of “G-A,” “G-B,” and “G-C” according to the value of the applicable similarity as depicted in FIG. 10.

Meanwhile, for example, in a case where the similarity regarding the evaluation criterion “social” is highest, the rating of the applicable evaluation target may be decided to be any one of “So-A,” “So-B,” and “So-C” according to the value of the applicable similarity as depicted in FIG. 10.

Further, for example, in a case where the similarity regarding the evaluation criterion “sustainability” is highest, the rating of the applicable evaluation target may be decided to be any one of “Su-A,” “Su-B,” and “Su-C” according to the value of the applicable similarity as depicted in FIG. 10.

The rating of an evaluation target by the rating section 140 according to the present embodiment has been described above.

Now, an example of an output of a rating result and so forth according to the present embodiment is described.

The outputting section 160 according to the present embodiment may output a rating result and so forth by the rating section 140 to a display.

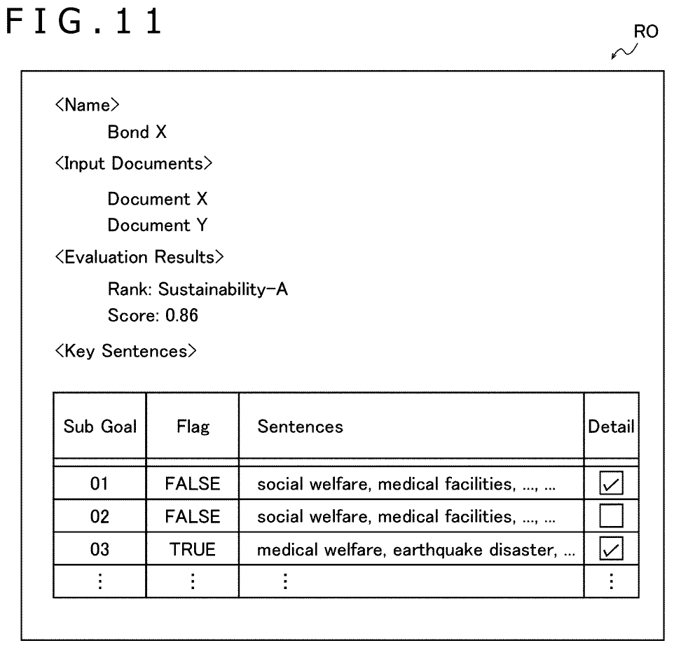

FIG. 11 is a view depicting an example of an output of a rating result and so forth according to the present embodiment.

As indicated by the output example RO depicted in FIG. 11, the outputting section 160 may output a name of an evaluation target (here, a bond name), a document name used in evaluation, a rating result, and a score used in rating (for example, a similarity between evaluation criterion definition information SI and by-sub goal score SS).

Further, the rating section 140 according to the present embodiment may extract a sentence that has contributed to improvement of similarity between an evaluation target and a comparison target for each sub goal from a text in which a characteristic of the evaluation target is described.

In this case, the outputting section 160 according to the present embodiment may display, in the form of a list, sentences (or words) that have contributed to improvement of similarity between an evaluation target and a comparison target for each sub goal as depicted in FIG. 11.

In the case of the example depicted in FIG. 11, the outputting section 160 displays, in the form of a list, such sentences as “social Welfare” and “medical facilities” extracted by the rating section 140 as sentences that have contributed to improvement of the similarity for sub goals “01” and “02.”

Further, the outputting section 160 displays, in the form of a list, such sentences as “medical Welfare” and “earthquake disaster” extracted by the rating section 140 as sentences that have contributed to improvement of the similarity for the sub goal “032.”

According to such list displays as described above, it is possible for the user to clearly identify the sentences that have contributed to improvement of the similarity described above.

Further, the outputting section 160 may display, in a highlighted manner, a sentence that has contributed to improvement of the similarity in a text in which a characteristic of an evaluation target is described (input sentence IS2).

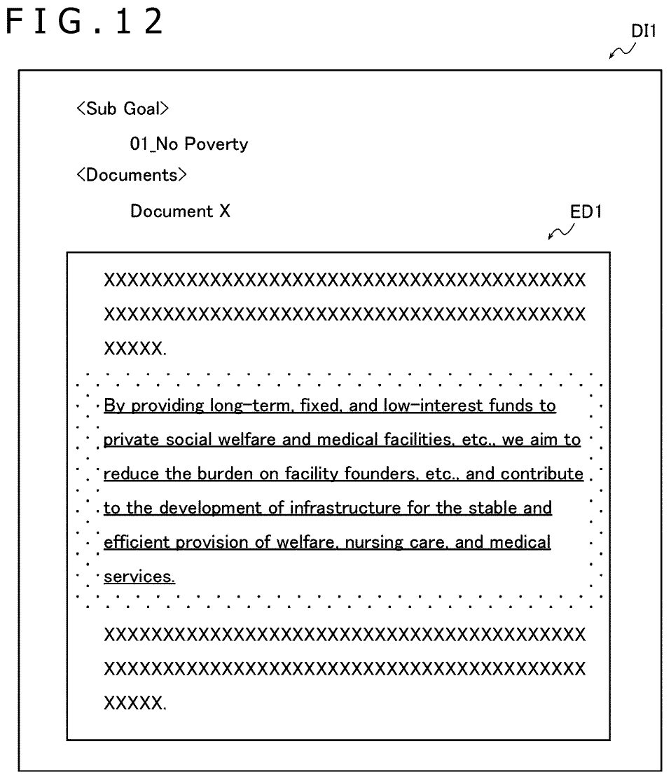

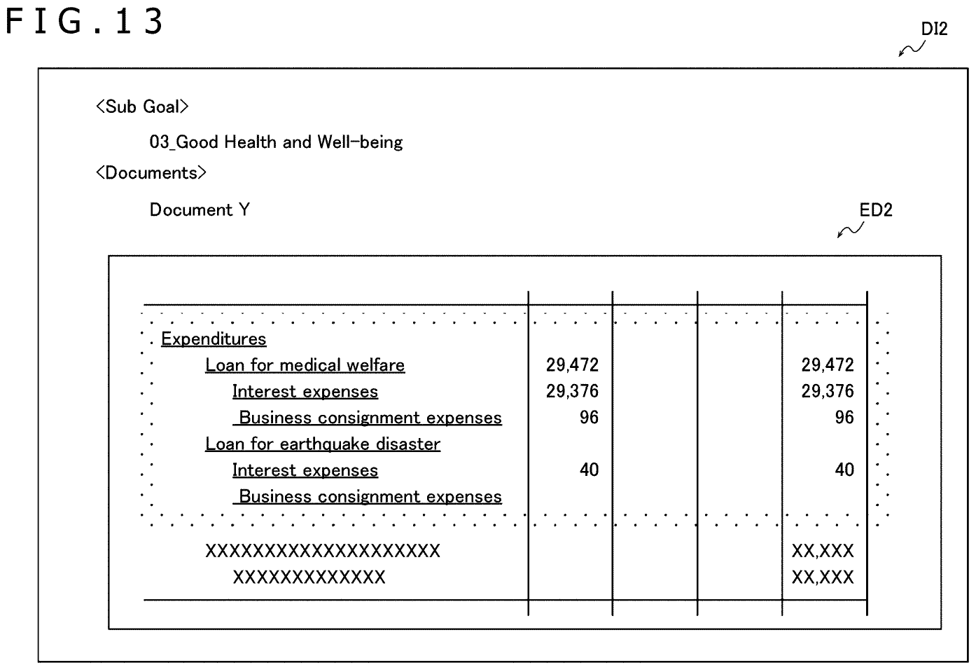

FIGS. 12 and 13 are views illustrating highlight display of a sentence that has contributed to improvement of the similarity between an evaluation target and a comparison target for each sub goal according to the present embodiment.

For example, in a case where the user selects the sub goal “01” from the list display in FIG. 11, the outputting section 160 may output such detailed information DI1 as depicted in FIG. 12.

The detailed information DI1 may include the selected sub goal “01,” a text name (document name) in which the relevant sentence is included, an excerpt ED1 of a part of the relevant text where the sentence is described, and the like.

The outputting section 160 may display, in a highlighted manner, in the excerpt ED1, the relevant sentence with a decoration such as a change of the background color or underlining, for example.

On the other hand, in a case where the user selects the sub goal “03” from the list display in FIG. 11, the outputting section 160 may output such detailed information DI2 as depicted in FIG. 13.

The detailed information DI2 may include the selected sub goal “03,” a text name (document name) in which the relevant sentence is included, an excerpt ED2 of a part in the relevant text where the relevant sentence is described, and so forth.

As depicted in the excerpt ED2, a sentence that has contributed to improvement of similarity between an evaluation target and a comparison target for each sub goal may be included in a table or a graph.

The rating section 140 can calculate, by inputting a sentence included in a table or a graph to the sentence feature extraction section 410, a degree of contribution of the sentence to the similarity between an evaluation target and a comparison target for each sub goal.

Further, the degree of contribution of a sentence to the similarity between an evaluation target and a comparison target for each sub goal may be used for correction proposal of the sentence to the user.

It is also possible for the outputting section 160 to output, for example, in regard to a certain sentence, the relevant sentence and a rating result in a case where the contribution of the relevant sentence to the similarity between an evaluation target and a comparison target for each sub goal has been improved.

At this time, the outputting section 160 may additionally output a sentence that relates to different receivables evaluated to have a high degree of contribution to the similarity to a comparison target in the sub goal that is a target.

According to such an output as described above, it is possible for the user to correct a sentence in order to enhance a rating result while referring to a specific example.

<<1.5. Details of Anomaly Detection>>

Now, anomaly detection by the anomaly detection section 150 according to the present embodiment is described in detail.

The rating section 140 according to the present embodiment may repetitively output a by-sub goal score SS regularly or irregularly in regard to the same evaluation target.

In this case, the anomaly detection section 150 according to the present embodiment may perform time series evaluation of an evaluation target for a predetermined goal.

Further, the anomaly detection section 150 according to the present embodiment can detect a predetermined anomalous pattern relating to evaluation of an evaluation target, in reference to the time series evaluation described above.

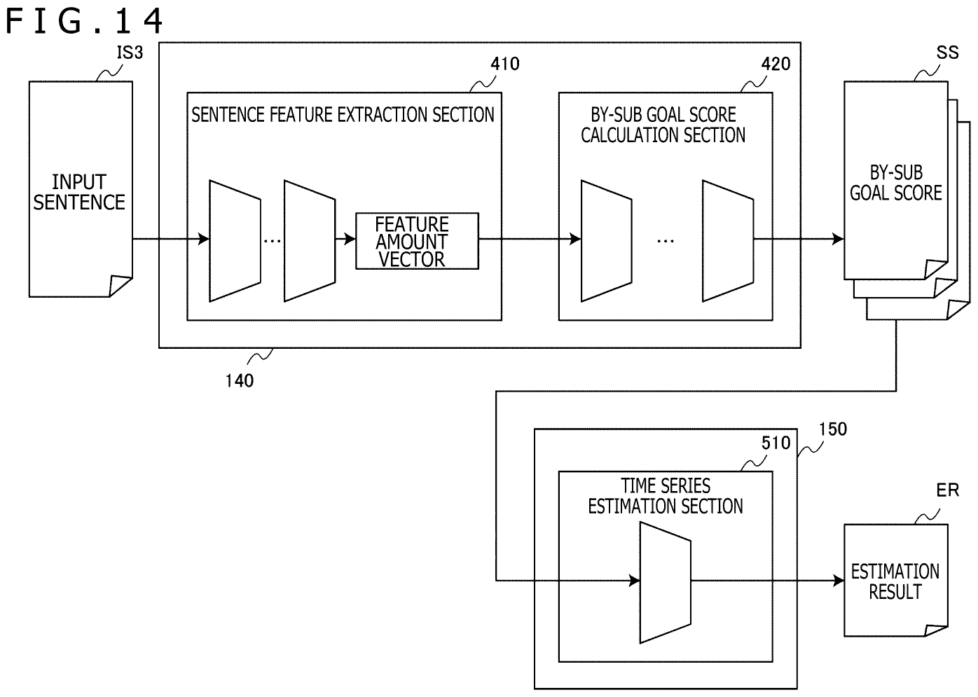

FIG. 14 is a view illustrating anomaly detection based on time series evaluation according to the present embodiment.

The rating section 140 according to the present embodiment receives an input sentence IS3 as an input thereto and repetitively outputs a by-sub goal score SS relating to a certain evaluation target regularly or irregularly.

Here, the input sentence IS2 is a free description sentence that includes non-financial information and in which a characteristic of an evaluation target is described, and the data format and the description language are not restrictive.

In a case where the evaluation target is a financial instrument such as receivables, the input sentence IS3 may include various texts including information concerning the financial instrument or an issuer of the applicable financial instrument.

The input sentence IS3 may include, for example, a shelf registration supplement, a securities report, an integrated report, a sustainability report, or the like.

The input sentence IS3 further includes a text in which a comment of a third party on an evaluation target is described.

The text in which a comment of a third party on an evaluation target is described may be, for example, a news reported by a third party (for example, a news organ) or a report issued issued by a third party (for example, an NGO/NPO) in regard to a financial instrument or an issuer of the financial instrument.

When the input sentence IS3 includes a text in which such a comment of a third party as described above is described, the rating section 140 can each time re-calculate a by-sub goal score SS on which the comment by the third party is reflected.

A time series estimation section 510 provided in the anomaly detection section 150 according to the present embodiment performs time series evaluation (time series estimation) in reference to multiple by-sub goal scores SS relating to the same evaluation target outputted from the rating section 140 and outputs an estimation result ER.

The time series estimation section 510 may perform the time series evaluation described above, for example, with use of a model of LSTM (Long Short Term Memory).

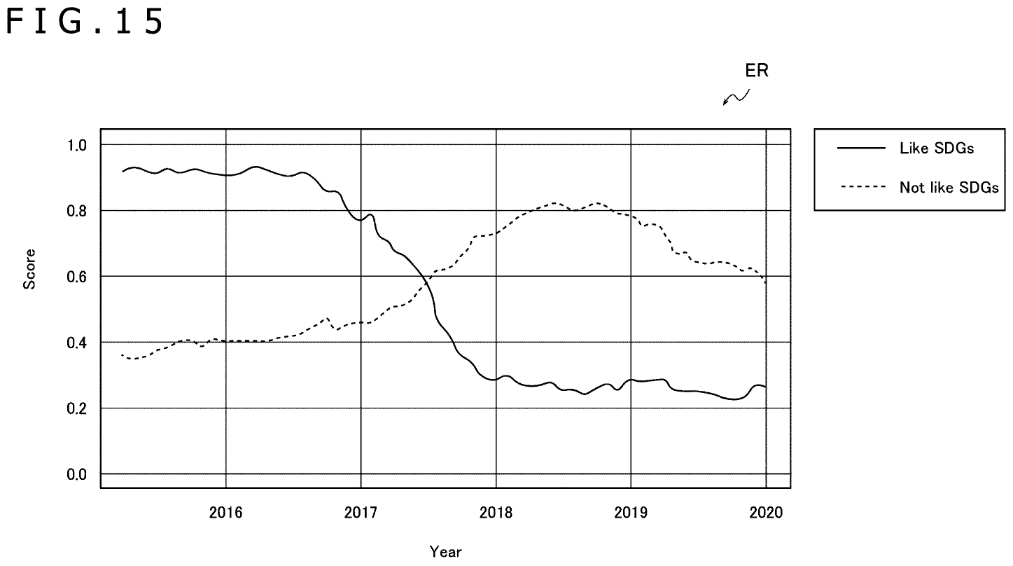

FIG. 15 is a view depicting an example of the estimation result ER of time series evaluation according to the present embodiment.

In the estimation result ER depicted in FIG. 15, transition in a time series of a score indicative of a probability that the evaluation target is an SDGs bond and a score indicative of a probability that the evaluation target is a non-SDGs bond is indicated.

The anomaly detection section 150 according to the present embodiment detects a predetermined anomalous pattern relating to evaluation of an evaluation target, according to such an estimation result ER as described above.

As the predetermined anomalous pattern, for example, a significant fluctuation of the evaluation (score) and so forth are available.

As an example, the anomalous pattern according to the present embodiment may include greenwash.

Here, greenwash indicates pretending to be environmentally friendly, while, in reality, being different and misleading consumers who are environmentally conscious.

For example, there are also supposed to be cases where, even in a case where it is determined, when a text or the like published by an issuer at the time of issuance of receivables that become an evaluation target is referred to, that the receivables and the issuer are highly conscious of the SDGs, there is divergence from reality or some divergence from reality will occur in the future.

In the anomaly detection according to the present embodiment, it is possible to detect such divergence as described above by performing time series evaluation of an evaluation target in reference to a comment made by a third party.

In the case of the example depicted in FIG. 15, the anomaly detection section 150 may detect greenwash in a case where the score indicative of the probability of the evaluation target being a non-SDGs bond is higher than the score indicative of the probability of the evaluation target being an SDGs bond.

In such a manner, the anomaly detection section 150 according to the present embodiment can detect such an anomalous pattern as greenwash and notify the user of information relating to the anomalous pattern, by performing time series evaluation of the same evaluation target.

<<1.6. Advantageous Effect>>

The evaluation method according to the present embodiment has been described above in detail.

With the evaluation method according to the present embodiment, by an evaluation work that has been performed manually until now being automated, it is possible to implement scale-out of the evaluation efficiency.

With the evaluation method according to the present embodiment, by laying open an evaluation algorithm and an architecture that are highly descriptive, it is possible to improve the transparency of the evaluation logic that has been a gray box and ensure the objectivity of evaluation.

With the evaluation method according to the present embodiment, by using an ideal pattern for each of the predetermined evaluation criteria, an intention of rating can be converted into explicit knowledge.

With the evaluation method according to the present embodiment, by extracting a sentence on which rating is to be based, improvement in descriptiveness concerning rating can be anticipated.

With the evaluation method according to the present embodiment, it is possible to recommend a sentence that improves rating to the user.

Further, with the evaluation method according to the present embodiment, rating can be modified each time by time series evaluation and it becomes possible to ensure the quality of credit information.

It is to be noted that, although the foregoing description is given taking evaluation of SDGs bonds as a main example, the application range of the evaluation method according to the present embodiment is not restricted to such an example as just described.

For example, it is also possible to use the evaluation method according to the present embodiment in rating of ordinary receivables based on non-financial information.

For example, the evaluation method according to the present embodiment can be applied also to evaluation of credit information of a borrower of personal loan. In this case, such operation is supposed that, by the evaluation method according to the present embodiment, credit information is applied using non-financial information of the borrower and, also after borrowing, follow-up survey is carried out to evaluate a bankruptcy risk in advance or the like.

Further, for example, the evaluation method according to the present embodiment can be applied also to personnel assessment. In this case, such operation is supposed that assessment is performed in reference to a sentence that includes information regarding an employee and, also after employment, time series evaluation based on an output of the employee is performed to ensure the quality of personnel assessment or the like.

### 2. Example of Hardware Configuration

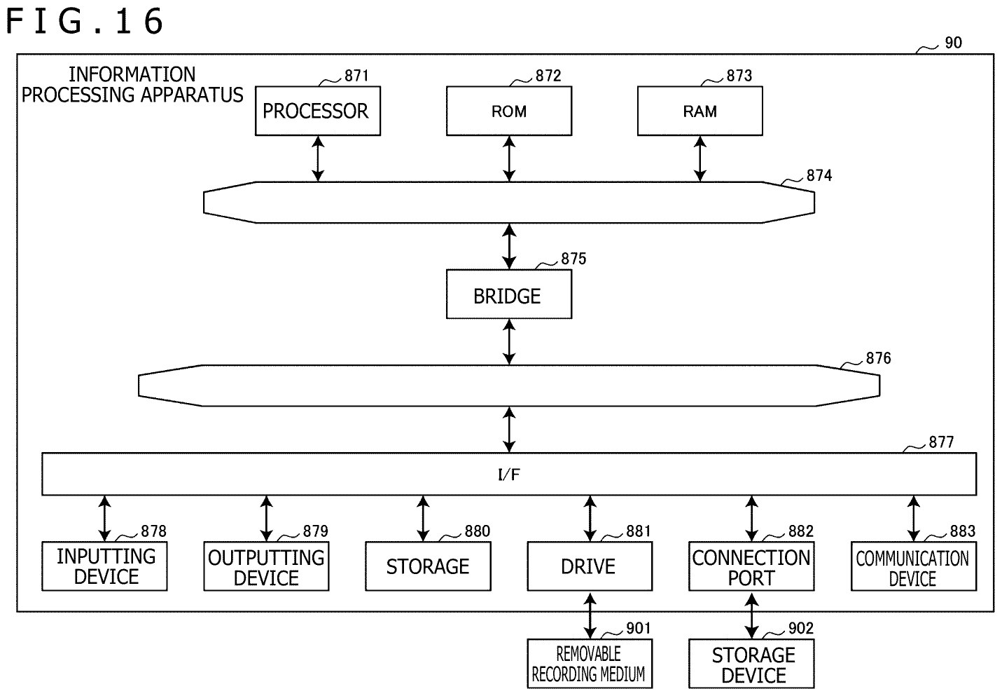

Now, an example of a hardware configuration of the evaluation apparatus 10 according to the embodiment of the present disclosure is described. FIG. 16 is a block diagram depicting an example of a hardware configuration of an information processing apparatus 90 according to the embodiment of the present disclosure. The information processing apparatus 90 may be an apparatus having a hardware configuration equivalent to that of the evaluation apparatus 10.

As depicted in FIG. 16, the information processing apparatus 90 includes, for example, a processor 871, a ROM 872, a RAM 873, a host bus 874, a bridge 875, an external bus 876, an interface 877, an inputting device 878, an outputting device 879, a storage 880, a drive 881, a connection port 882, and a communication device 883. It is to be noted that the hardware configuration depicted in FIG. 16 is an example, and some of the components may be omitted. Meanwhile, the information processing apparatus 90 may further include a component or components other than the components described above.

(Processor 871)

The processor 871 functions, for example, as an arithmetic processing unit or a control device and controls general operation or part of operation of the components according to various programs recorded in the ROM 872, the RAM 873, the storage 880, or a removable recording medium 901.

(ROM 872, RAM 873)

The ROM 872 is means for storing a program to be read into the processor 871, data to be used for arithmetic operation, and so forth. Into the RAM 873, for example, a program to be read into the processor 871, various parameters that suitably change when the program is executed, and so forth are stored temporarily or permanently.

(Host Bus 874, Bridge 875, External Bus 876, Interface 877)

The processor 871, the ROM 872, and the RAM 873 are connected to each other, for example, by the host bus 874 that can perform high speed data transmission. Meanwhile, the host bus 874 is connected to the external bus 876 whose data transmission speed is relatively low, via the bridge 875. Further, the external bus 876 is connected to various components via the interface 877.

(Inputting Device 878)

As the inputting device 878, for example, a mouse, a keyboard, a touch panel, a button, a switch, a lever, and so forth are used. Further, as the inputting device 878, a remote controller (hereinafter referred to as remote control) which can transmit a control signal with use of infrared rays or some other radio waves is sometimes used. Further, the inputting device 878 includes a sound inputting device such as a microphone.

(Outputting Device 879)

The outputting device 879 is, for example, a device capable of visually or auditorily notifying the user of acquired information such as a display device exemplified by a CRT (Cathode Ray Tube), an LCD, or an organic EL, an audio outputting device such as a speaker or a headphone, a printer, a portable telephone set, or a facsimile. Further, the outputting device 879 according to the present disclosure includes various vibration devices capable of outputting tactile stimulation.

(Storage 880)

The storage 880 is a device for storing various kinds of data. As the storage 880, for example, a magnetic storage device such as a hard disk drive (HDD), a semiconductor storage device, an optical storage device, a magneto-optical storage device, and so forth are used.

(Drive 881)

The drive 881 is, for example, a device that reads out information recorded on the removable recording medium 901 such as a magnetic disk, an optical disk, a magneto-optical disk, or a semiconductor memory or writes information into the removable recording medium 901.

(Removable Recording Medium 901)

The removable recording medium 901 is, for example, any of a DVD medium, a Blu-ray (registered trademark) medium, an HD DVD medium, various semiconductor storage media, and so forth. Naturally, the removable recording medium 901 may be, for example, an IC card, electronic equipment, or the like in which a contactless IC chip is incorporated.

(Connection Port 882)

The connection port 882 is, for example, a port for connecting external connection equipment 902 such as a USB (Universal Serial Bus) port, an IEEE 1394 port, a SCSI (Small Computer System Interface), an RS-232C port, or an optical audio terminal.

(External Connection Equipment 902)

The external connection equipment 902 is, for example, a printer, a portable music player, a digital camera, a digital video camera, an IC recorder, or the like.

(Communication Device 883)

The communication device 883 is a communication device for connecting to a network and is, for example, a wired or wireless LAN, a communication card for Bluetooth (registered trademark) or WUSB (Wireless USB), a router for optical communication, a router for ADSL (Asymmetric Digital Subscriber Line), a modem for various kinds of communication, or the like.

### 3. Summary

As described above, the evaluation apparatus 10 according to an embodiment of the present disclosure includes an evaluation section 120 that performs evaluation of an evaluation target for a predetermined goal including multiple sub goals, in reference to a text in which a characteristic of the evaluation target is described.

Meanwhile, the evaluation section 120 according to an embodiment of the present embodiment has one of the characteristics in that it inputs, to a first classifier generated by supervised learning that uses a feature amount extracted from a text in which a characteristic of a comparison target evaluated to satisfy any one of the predetermined evaluation criteria defined by a combination of multiple sub goals relating to the predetermined goal is described, a feature amount extracted from a text in which the characteristic of the evaluation target is described, to acquire a similarity between the evaluation target and the comparison target for each of the sub goals, and evaluates, in reference to the similarity between the evaluation target and the comparison target for each of the sub goals and an ideal pattern for each of the predetermined evaluation criteria defined by a combination of multiple sub goals, the similarity between the ideal pattern for each of the predetermined evaluation criteria and the evaluation target.

With the configuration described above, while the quality of evaluation for a predetermined goal is ensured, the cost for the evaluation can be reduced effectively.

Although the preferred embodiment of the present disclosure has been described above in detail with reference to the accompanying drawings, the technical scope of the present disclosure is not restricted to such an example as just described. It is apparent that those who have ordinary knowledge in the technical field of the present disclosure can conceive of various alterations or modifications within the scope of the technical idea described in the claims, and it is recognized that they also naturally fall within the technical scope of the present disclosure.

Further, the steps relating to the processes described in the present specification need not necessarily be processed in a time series along the order described in the flow charts or sequence diagrams. For example, the steps relating to processing of the individual devices may be processed in an order different from the order described or may be processed in parallel.

Further, the series of processes by the devices described in the present specification may be implemented using any of software, hardware, and a combination of software and hardware. Programs that configure the software are stored in advance, for example, in a computer-readable non-transitory storage medium (non-transitory computer readable medium) provided inside or outside of each device. Further, each program is read into a RAM, for example, at the time of execution thereof by a computer, and is executed by various processors. The storage medium is, for example, a magnetic disk, an optical disk, a magneto-optical disk, a flash memory, or the like. Further, the computer program described above may be distributed, for example, through a network without use of a storage medium.

Further, the advantageous effects described in the present specification are explanatory or exemplary to the last and are not restrictive. In short, the technology according to the present disclosure can achieve, together with the advantageous effects described above or in place of the advantageous effects described above, other advantageous effects that are apparent to those skilled in the art from the description of the present specification.

It is to be noted that such configurations as described below also belong to the technical scope of the present disclosure.

(1)

An information processing apparatus including:
an evaluation section that performs, in reference to a text in which a characteristic of an evaluation target is described, evaluation of the evaluation target for a predetermined goal including multiple sub goals, in which
the evaluation section
   inputs, to a first classifier generated by supervised learning that uses a feature amount extracted from a text in which a characteristic of a comparison target evaluated to satisfy any one of predetermined evaluation criteria defined by a combination of respective ones of the multiple sub goals of the predetermined goal is described, a feature amount extracted from the text in which the characteristic of the evaluation target is described, to acquire a similarity between the evaluation target and the comparison target for each of the sub goals, and
   evaluates, in reference to the similarity between the evaluation target and the comparison target for each of the sub goals and an ideal pattern for each of the predetermined evaluation criteria defined by a combination of respective ones of the multiple sub goals, a similarity between the ideal pattern for each of the predetermined evaluation criteria and the evaluation target.
      (2)

The information processing apparatus according to (1) above, in which
the evaluation section performs rating of the evaluation target for the predetermined goal in reference to the similarity between the ideal pattern for each of the predetermined evaluation criteria and the evaluation target.
   (3)

The information processing apparatus according to (1) or (2) above, in which
the evaluation section extracts, from the text in which the characteristic of the evaluation target is described, a sentence that has contributed to improvement of the similarity between the evaluation target and the comparison target for each of the sub goals.
   (4)

The information processing apparatus according to (3) above, further including:
an outputting section that outputs a result of the evaluation by the evaluation section.
   (5)

The information processing apparatus according to (4) above, in which
the outputting section displays, in a form of a list, sentences that have contributed to improvement of the similarity between the evaluation target and the comparison target for each of the sub goals.
   (6)

The information processing apparatus according to (4) or (5) above, in which
the outputting section displays, in a highlighted manner, in the text in which the characteristic of the evaluation target is described, a sentence that has contributed to improvement of the similarity between the evaluation target and the comparison target for each of the sub goals.
   (7)

The information processing apparatus according to any one of (1) through 6 above, in which
the evaluation section performs time series evaluation of the evaluation target for the predetermined goal.
   (8)

The information processing apparatus according to (7) above, in which
the evaluation section detects a predetermined anomalous pattern relating to evaluation of the evaluation target, in reference to the time series evaluation.
   (9)

The information processing apparatus according to (8) above, in which
the predetermined anomalous pattern includes greenwash.
   (10)

The information processing apparatus according to any one of (7) through (9) above, in which
the evaluation section performs the time series evaluation in reference to the text in which the characteristic of the evaluation target is described and a text in which a comment of a third party on the evaluation target is described.
   (11)

The information processing apparatus according to any one of (1) through (10) above, in which
the evaluation section determines, in reference to a text in which a characteristic of a screening target is described, whether or not the screening target is appropriate as the evaluation target.
   (12)

The information processing apparatus according to (11) above, in which
the evaluation section acquires a similarity between the comparison target and the screening target for each of the predetermined evaluation criteria by inputting, to a second classifier generated by supervised learning that uses the feature amount extracted from the text in which the characteristic of the comparison target evaluated to satisfy any one of the predetermined evaluation criteria is described, a feature amount extracted from the text in which the characteristic of the screening target is described, and determines, in reference to the similarity, whether or not the screening target is appropriate as the evaluation target.
   (13)

The information processing apparatus according to any one of (1) through (12) above, in which
the evaluation target includes a financial instrument.
   (14)

The information processing apparatus according to (13) above, in which
the text in which the characteristic of the evaluation target is described includes information concerning the financial instrument or an issuer of the financial instrument.
   (15)

The information processing apparatus according to any one of (1) through (14) above, in which
the predetermined goal includes SDGs.
   (16)

The information processing apparatus according to (15) above, in which
the predetermined evaluation criteria include a green criterion, a social criterion, and a sustainability criterion.
   (17)

An information processing method performed by a processor, including:
performing, in reference to a text in which a characteristic of an evaluation target is described, evaluation of the evaluation target for a predetermined goal including multiple sub goals, in which
the performing evaluation further includes
   inputting, to a first classifier generated by supervised learning that uses a feature amount extracted from a text in which a characteristic of a comparison target evaluated to satisfy any one of predetermined evaluation criteria defined by a combination of respective ones of the multiple sub goals of the predetermined goal is described, a feature amount extracted from the text in which the characteristic of the evaluation target is described, to acquire a similarity between the evaluation target and the comparison target for each of the sub goals, and
   evaluating, in reference to the similarity between the evaluation target and the comparison target for each of the sub goals and an ideal pattern for each of the predetermined evaluation criteria defined by a combination of respective ones of the multiple sub goals, a similarity between the ideal pattern for each of the predetermined evaluation criteria and the evaluation target.
      (18)

A program for causing a computer to function as an information processing apparatus that includes an evaluation section that performs, in reference to a text in which a characteristic of an evaluation target is described, evaluation of the evaluation target for a predetermined goal including multiple sub goals,
the evaluation section
   inputting, to a first classifier generated by supervised learning that uses a feature amount extracted from a text in which a characteristic of a comparison target evaluated to satisfy any one of predetermined evaluation criteria defined by a combination of respective ones of the multiple sub goals of the predetermined goal is described, a feature amount extracted from the text in which the characteristic of the evaluation target is described, to acquire a similarity between the evaluation target and the comparison target for each of the sub goals, and
   evaluating, in reference to the similarity between the evaluation target and the comparison target for each of the sub goals and an ideal pattern for each of the predetermined evaluation criteria defined by a combination of respective ones of the multiple sub goals, a similarity between the ideal pattern for each of the predetermined evaluation criteria and the evaluation target.

### REFERENCE SIGNS LIST

10: Evaluation apparatus
110: Inputting section
120: Evaluation section
130: Screening section
140: Rating section
150: Anomaly detection section
160: Outputting section
310: Sentence feature extraction section
320: Target score calculation section
330: Map generation section
410: Sentence feature extraction section
420: By-sub goal score calculation section
430: Similarity calculation section
510: Time series estimation section

1. An information processing apparatus comprising:
an evaluation section that performs, in reference to a text in which a characteristic of an evaluation target is described, evaluation of the evaluation target for a predetermined goal including multiple sub goals, wherein
the evaluation section
inputs, to a first classifier generated by supervised learning that uses a feature amount extracted from a text in which a characteristic of a comparison target evaluated to satisfy any one of predetermined evaluation criteria defined by a combination of respective ones of the multiple sub goals of the predetermined goal is described, a feature amount extracted from the text in which the characteristic of the evaluation target is described, to acquire a similarity between the evaluation target and the comparison target for each of the sub goals, and
evaluates, in reference to the similarity between the evaluation target and the comparison target for each of the sub goals and an ideal pattern for each of the predetermined evaluation criteria defined by a combination of respective ones of the multiple sub goals, a similarity between the ideal pattern for each of the predetermined evaluation criteria and the evaluation target.

2. The information processing apparatus according to claim 1, wherein
the evaluation section performs rating of the evaluation target for the predetermined goal in reference to the similarity between the ideal pattern for each of the predetermined evaluation criteria and the evaluation target.

3. The information processing apparatus according to claim 1, wherein
the evaluation section extracts, from the text in which the characteristic of the evaluation target is described, a sentence that has contributed to improvement of the similarity between the evaluation target and the comparison target for each of the sub goals.

4. The information processing apparatus according to claim 3, further comprising:
an outputting section that outputs a result of the evaluation by the evaluation section.

5. The information processing apparatus according to claim 4, wherein
the outputting section displays, in a form of a list, sentences that have contributed to improvement of the similarity between the evaluation target and the comparison target for each of the sub goals.

6. The information processing apparatus according to claim 4, wherein
the outputting section displays, in a highlighted manner, in the text in which the characteristic of the evaluation target is described, a sentence that has contributed to improvement of the similarity between the evaluation target and the comparison target for each of the sub goals.

7. The information processing apparatus according to claim 1, wherein
the evaluation section performs time series evaluation of the evaluation target for the predetermined goal.

8. The information processing apparatus according to claim 7, wherein
the evaluation section detects a predetermined anomalous pattern relating to evaluation of the evaluation target, in reference to the time series evaluation.

9. The information processing apparatus according to claim 8, wherein
the predetermined anomalous pattern includes greenwash.

10. The information processing apparatus according to claim 7, wherein
the evaluation section performs the time series evaluation in reference to the text in which the characteristic of the evaluation target is described and a text in which a comment of a third party on the evaluation target is described.

11. The information processing apparatus according to claim 1, wherein
the evaluation section determines, in reference to a text in which a characteristic of a screening target is described, whether or not the screening target is appropriate as the evaluation target.

12. The information processing apparatus according to claim 11, wherein
the evaluation section acquires a similarity between the comparison target and the screening target for each of the predetermined evaluation criteria by inputting, to a second classifier generated by supervised learning that uses the feature amount extracted from the text in which the characteristic of the comparison target evaluated to satisfy any one of the predetermined evaluation criteria is described, a feature amount extracted from the text in which the characteristic of the screening target is described, and determines, in reference to the similarity, whether or not the screening target is appropriate as the evaluation target.

13. The information processing apparatus according to claim 1, wherein
the evaluation target includes a financial instrument.

14. The information processing apparatus according to claim 13, wherein
the text in which the characteristic of the evaluation target is described includes information concerning the financial instrument or an issuer of the financial instrument.

15. The information processing apparatus according to claim 1, wherein
the predetermined goal includes SDGs.

16. The information processing apparatus according to claim 15, wherein
the predetermined evaluation criteria include a green criterion, a social criterion, and a sustainability criterion.

17. An information processing method performed by a processor, comprising:
performing, in reference to a text in which a characteristic of an evaluation target is described, evaluation of the evaluation target for a predetermined goal including multiple sub goals, wherein
the performing evaluation further includes
inputting, to a first classifier generated by supervised learning that uses a feature amount extracted from a text in which a characteristic of a comparison target evaluated to satisfy any one of predetermined evaluation criteria defined by a combination of respective ones of the multiple sub goals of the predetermined goal is described, a feature amount extracted from the text in which the characteristic of the evaluation target is described, to acquire a similarity between the evaluation target and the comparison target for each of the sub goals, and
evaluating, in reference to the similarity between the evaluation target and the comparison target for each of the sub goals and an ideal pattern for each of the predetermined evaluation criteria defined by a combination of respective ones of the multiple sub goals, a similarity between the ideal pattern for each of the predetermined evaluation criteria and the evaluation target.

18. A program for causing a computer to function as an information processing apparatus that includes an evaluation section that performs, in reference to a text in which a characteristic of an evaluation target is described, evaluation of the evaluation target for a predetermined goal including multiple sub goals,
the evaluation section
inputting, to a first classifier generated by supervised learning that uses a feature amount extracted from a text in which a characteristic of a comparison target evaluated to satisfy any one of predetermined evaluation criteria defined by a combination of respective ones of the multiple sub goals of the predetermined goal is described, a feature amount extracted from the text in which the characteristic of the evaluation target is described, to acquire a similarity between the evaluation target and the comparison target for each of the sub goals, and
evaluating, in reference to the similarity between the evaluation target and the comparison target for each of the sub goals and an ideal pattern for each of the predetermined evaluation criteria defined by a combination of respective ones of the multiple sub goals, a similarity between the ideal pattern for each of the predetermined evaluation criteria and the evaluation target.
